(19) United States
(12) Patent Application Publication
(10) Pub. No.: US 2016/0295834 A1
(43) Pub. Date: Oct. 13, 2016

(54) CAT SCRATCHER ATTRACTANT DEVICE

(71) Applicant: Worldwise, Inc., San Rafael, CA (US)

(72) Inventors: Charles Floyd, Oakland, CA (US); Michael Risso, Napa, CA (US); Aimee Diskin, Napa, CA (US); Hannah Rosenberg, San Francisco, CA (US); Sara Paculdo, Novato, CA (US)

(21) Appl. No.: 14/682,925

(22) Filed: Apr. 9, 2015

(51) Int. Cl. A01K 15/02

(52) U.S. Cl. CPC A01K 15/024; A01K 15/025

(57) ABSTRACT

A cat scratcher attractant device having a vertically extending axis, a housing having a hollow interior, a motor supported by said housing and enclosed within the hollow interior, the motor having a rotatable shaft extending vertically along said central axis and a power supply for selectively activating the motor. A wand is provided with an attractant, the wand having first and second ends, the first end being fixed to the rotatable shaft and the second end being fixed to the attractant. The housing further includes a receiving slot and a scratcher, the scratcher being sized to be received and selectively retained by the receiving slot such that the scratcher extends from the housing and the attractant rotates above a portion of the scratcher when the motor is activated.

### TECHNICAL FIELD

The present invention involves a cat scratching-based attractant and amusement device capable of encouraging a domestic cat to employ a dedicated scratching surface rather than scratching furniture, carpets and drapes and to maintain a cat's interest for prolonged periods of time in doing so.

### BACKGROUND OF THE INVENTION

It is well recognized that domestic cats crave scratching as part of their natural instinctive character. If a dedicated scratching surface is not provided, domestic cats would generally satisfy their need to scratch by turning to furniture, curtains and other articles which can be substantially damaged as a consequence. Often times, pet cats will not only climb over furniture, specially upholster chairs and sofas, but will use such furniture and carpeting to condition their claws through deliberate repeated clawing, pulling and tearing actions specifically with their forepaws. As noted, this clawing activity appears to be an irresistible natural impulse for cats and can be the source of great aggravation to the pet owner.

There are a number of vendors of pet and pet related products that have offered implements dedicated to alleviating the need of a cat to scratch. These include cat scratching posts and pads comprised on of, for example, carpet, sisal, seagrass, rope and cardboard. In most instances, the cat scratching surface is simply made available to the cat relying upon the cat to seek it out on its own. To encourage cats to use a dedicated scratching surface, often times, a pet product manufacturer will infuse catnip or similar attractant into the body of the scratching surface. However, being merely a passive post or pad, cats will often times get bored and engage in destructive activity which could have been avoided if the attempt was made to actively attract a cat to the scratching surface and to keep it engaged with the scratcher by playing upon a cat's natural curiosity to seek out and swat moving objects as it would prey.

It is thus an object to the present invention to provide a cat scratcher attractant device which is capable of maintaining a cat's interest for prolonged periods.

Yet a further object of the present invention is to provide a scratcher which will actively be sought out by a pet to the exclusion of furniture drapes and carpets thus minimizing the cat's tendency to destroy, through scratching, valuable household furniture.

These and further objects will be more readily apparent when considering the following disclosure and appended claims.

### SUMMARY OF THE INVENTION

The present invention is directed to a cat scratcher attractant device comprising a vertically extending axis, a housing having a hollow interior, a motor supported by said housing and enclosed within said hollow interior, said motor having a rotatable shaft positioned along said vertically extending axis, a power supply for selectively activating said motor, a wand and an attractant, said wand having first and second ends, said first end being fixed to said rotatable shaft and said second end being fixed to said attractant, said housing further comprising a receiving slot and a scratcher, said scratcher being sized to be received and selectively retained by said receiving slot such that said scratcher extends from said housing and said attractant rotates above a portion of said scratcher when said motor is activated.

The present invention is also directed to a cat scratcher attractant device comprising a vertically extending axis, a housing having a hollow interior, a motor supported by said housing and enclosed within said hollow interior, said motor having a rotatable shaft positioned along said vertically extending axis, a power supply for selectively activating said motor, a wand and an attractant, said wand having first and second ends, said first and being fixed to said rotatable shaft and said second end being fixed to said attractant, said housing further comprising a receiving slot and a scratcher, said scratcher being sized to be received and selectively retained by said receiving slot such that said scratcher extends from said housing and said attractant rotates above a portion of said scratcher when said motor is activated and further comprising a base, said base having a top and bottom, said bottom being configured to reside upon a support surface for said cat scratcher attractant device and said top being configured to receive and support said housing.

### BRIEF DESCRIPTION OF THE FIGURES

FIG. 1 is a perspective view of the first embodiment of the present invention.

FIG. 2 is a cutaway view of a portion of the housing used in the present invention showing some of its internal components.

FIG. 3 is yet another cutaway view of a portion of the housing used in the present in invention showing additional internal components.

FIGS. 4A & 4B are side and perspective views of a second embodiment of the present invention having captured a cat scratcher for use with a domestic cat.

FIG. 5 is a side view of the first embodiment of the present invention as shown in FIG. 1 having captured a cat scratcher for use with the domestic cat.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

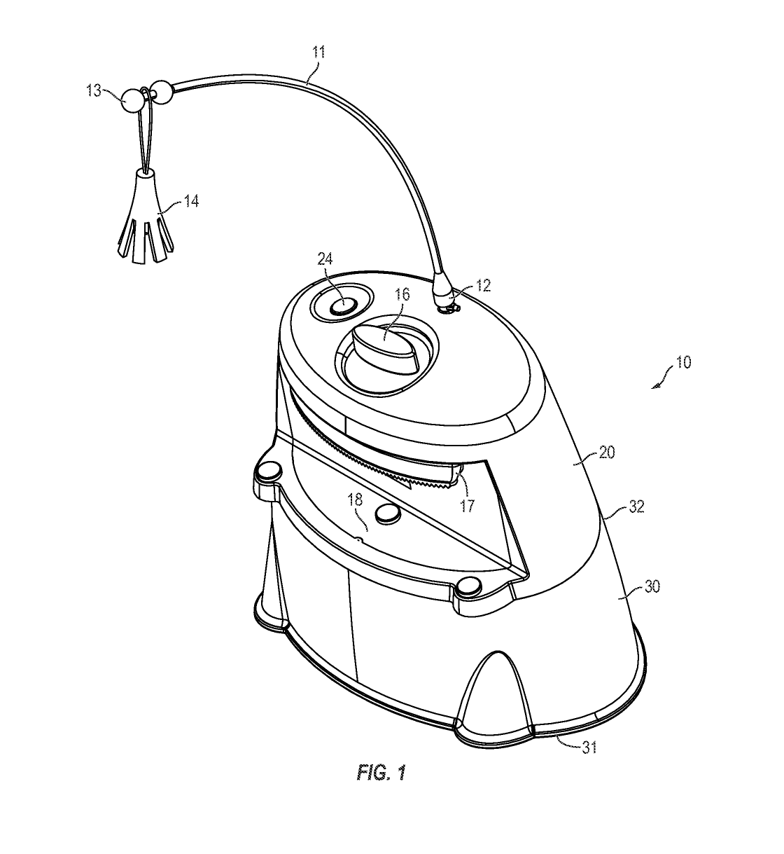

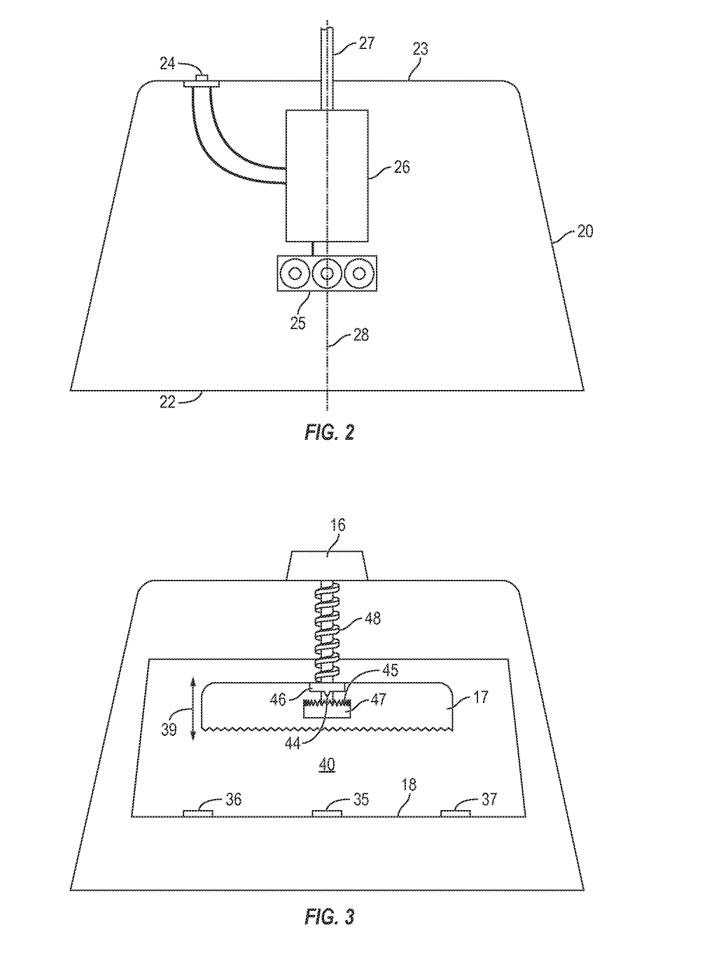

Turning first to FIG. 1, the housing of the present invention designed to selectively capture a scratcher is depicted. Specifically, attractant device 10 is shown in one of its embodiments including housing 20 and base 30. Housing 20 is characterized as having a hollow interior which supports motor 26 having rotatable shaft 27 positioned along vertically extending axis 28. Housing 20 also includes power supply 25, in this instance shown as being comprised of a plurality of batteries although motor 26 could be powered externally from a separate battery pack or AC outlet. Motor 26 can be selectively activated by switch 24 accessible to a user on the surface of upper housing 20.

Again turning to FIG. 1, the present cat scratcher attractant device is shown to include wand 11 and attractant 14, the latter being any one or a number of products which are well known to attract the attention of a domestic cat such as a feathered bundle, for example. Wand 11, generally being a plastic rod which can be molded in various lengths and have a curved profile as depicted in FIG. 1. In use, electric motor 26 located within upper housing 20 rotates wand 11 by virtue of its connection at end 12 to rotatable shaft 27. Wand 11 extends upwardly and radially outwardly from rotatable shaft 11 such that attractant 14 supported at end 13 of wand 11 spins about housing 10 in a motion that is naturally attracting to a domestic cat as a result of its inherent desire to swat and pounce upon moving prey.

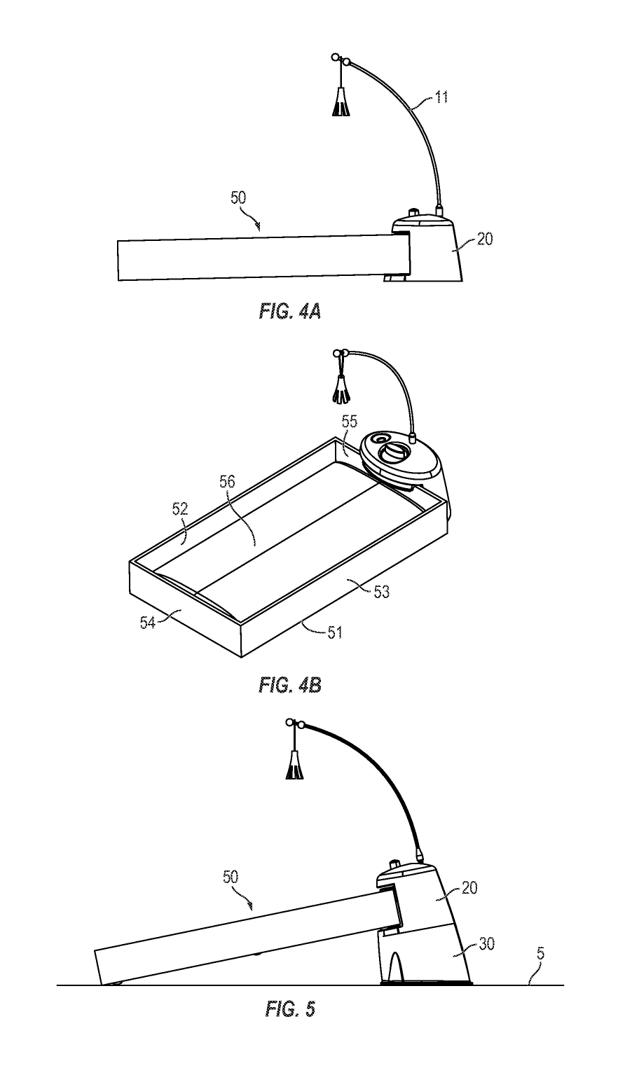

It is further noted that housing 20 includes receiving slot 40 which includes opposing top and bottom surfaces 17 and 18 distanced from one another for frictionally receiving a scratcher. In this regard, reference is made to FIGS. 3, 4A and 4B.

As noted, scratcher 56 is frictionally joined to upper housing 20 frictionally within slot 40. As a preferred embodiment, scratcher 56 as assembly 50 including a frame composed of substantially planar bottom 51 and side walls 52, 53, 54 and 55. Such an assembly helps to confine scratching surface debris from being broadcast about the present device is a result of vigorous scratching activity. When such an assembly is adopted, vertically extending side wall 55 is dimensioned such that it fits within slot 40 and can be retained therein by adjusting knob 16 which causes top surface 17 to move forward and away from bottom surface 18 thus selectively “clamping” side wall 55 within slot 40 as depicted in FIG. 4A. Resilient pads 35, 36 and 37 help to frictionally prevent the scratcher from being pulled from slot 40 during vigorous clawing.

In turning to FIG. 3, top surface 17 is shown to be movable in the direction of arrows 39 by the turning of adjustment knob 16. Upper surface 17 moves along helix 48 to make such an adjustment noting further that when the appropriate scratcher is inserted within receiving slot 40 and upper surface 17 drawn towards lower surface 18, contacting disk 47 having toothed surface 45 is drawn toward mating disk 46 such that protrusion 44 engages one of the teeth to prevent surface 17 from inadvertently withdrawing from surface 18 as a result of vigorous clawing activity.

As noted, the embodiment of the present invention depicted by FIGS. 4A and 4B employs only upper housing 20. This positions receiving slot 40 relatively close to support surface 5 such that scratcher assembly 50 extends substantially horizontally from housing 20. Such an embodiment is particularly useful for older cats and for those that may engage in relatively aggressive scratching activity which would tend to knock over a device such as that shown in the FIG. 5 embodiment.

In comparing housing 10 of FIG. 1 and that of FIGS. 4A and 4B, it is apparent that the latter is devoid of base 30. Base 30 is configured to reside upon support surface 5 at its bottom edge 31 and to support upper housing 20 at upper edge 32 which interfaces with lower edge 22 of housing 20. Thus, base 30 provides a stable support for housing 20 as best seen in reference to FIG. 5. It is noted that when upper housing 20 and base 30 are joined and scratcher assembly 50 is caused to frictionally engage slot 40, scratcher assembly 50 extends from upper housing 20 diagonally or at an incline. This further enhances the versatility of the device and maintains the interest of a pet cat for the present invention can alternate between a horizontal and inclined scratcher.

In use, whether the embodiment of FIGS. 4A and 4B or the embodiment of FIG. 5 is selected, attractant 14 rotates above a portion of scratcher 56 when motor 26 is activated. As wand 11 spins about vertical axis 28, a cat's natural instinct to swat and pounce will result in the pet's attempt to get close to the attractant and, in doing so will step onto scratching surface 56 thus satisfying its need to scratch as well as its need to pursue prey. His combination of parts synergistically maintains a cat's interest and satisfies multiple needs far longer than would be the case when either a scratcher alone or a rotating attractant alone are offered to a domestic cat.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat scratcher attractant device comprising a vertically extending axis, a housing having a hollow interior, a motor supported by said housing and enclosed within said hollow interior, said motor having a rotatable shaft positioned along said vertically extending axis, a power supply for selectively activating said motor, a wand and an attractant, said wand having first and second ends, said first end being fixed to said rotatable shaft and said second end being fixed to said attractant, said housing further comprising a receiving slot and a scratcher, said scratcher being sized to be received and selectively retained by said receiving slot such that said scratcher extends from said housing and said attractant rotates above a portion of said scratcher when said motor is activated.

2. The cat scratcher attractant device of claim 1 wherein said receiving slot is characterized as comprising opposing top and bottom surfaces distanced from one another for frictionally receiving said scratcher.

3. The cat scratcher attractant device of claim 2 wherein said distance between said opposing top and bottom surfaces is adjustable to receive scratchers of varying thicknesses.

4. The cat scratcher attractant device of claim 3 where in the distance between said opposing top and bottom surfaces is adjustable by a user by a control switch accessible on a surface of said housing.

5. The cat scratcher attractant device of claim 1 wherein said scratcher comprises a scratching surface housed within a frame, said frame comprising a substantially planar bottom, said substantially planar bottom being substantially coextensive with said scratching surface and side walls extending from said substantially planar bottom, said scratching surface being contained within said sidewalls.

6. The cat scratcher attractant device of claim 5 wherein said sidewalls are sized to be frictionally received within said receiving slot.

7. A cat scratcher attractant device comprising a vertically extending axis, a housing having a hollow interior, a motor supported by said housing and enclosed within said hollow interior, said motor having a rotatable shaft positioned along said vertically extending axis, a power supply for selectively activating said motor, a wand and an attractant, said wand having first and second ends, said first and being fixed to said rotatable shaft and said second end being fixed to said attractant, said housing further comprising a receiving slot and a scratcher, said scratcher being sized to be received and selectively retained by said receiving slot such that said scratcher extends from said housing and said attractant rotates above a portion of said scratcher when said motor is activated and further comprising a base, said base having a top and bottom, said bottom being configured to reside upon a support surface for said cat scratcher attractant device and said top being configured to receive and support said housing.

8. The cat scratcher attractant device of claim 7 wherein said scratcher extends diagonally from said housing, an edge of said scratcher being in contact with said support surface.

9. The cat scratcher attractant device of claim 7 wherein said receiving slot is characterized as comprising opposing top and bottom surfaces distanced from one another for frictionally receiving said scratcher.

10. The cat scratcher attractant device of claim 9 wherein said distance between said opposing top and bottom surfaces is adjustable to receive scratchers of varying thicknesses.

11. The cat scratcher attractant device of claim 10 where in the distance between said opposing top and bottom surfaces is adjustable by a user by a control switch accessible on a surface of said housing.

12. The cat scratcher attractant device of claim 7 wherein said scratcher comprises a scratching surface housed within a frame, said frame comprising a substantially planar bottom, said substantially planar bottom being substantially coextensive with said scratching surface and side walls extending from said substantially planar bottom, said scratching surface being contained within said sidewalls.

13. The cat scratcher attractant device of claim 12 wherein said sidewalls are size to be frictionally received within said receiving slot.
